(19) United States
(12) Patent Application Publication
(10) Pub. No.: US 2011/0246276 A1
(43) Pub. Date: Oct. 6, 2011

(54) AUGMENTED- REALITY MARKETING WITH VIRTUAL COUPON

(76) Inventors: Richard Ross Peters, Mission Viejo, CA (US); Amit Karmarkar, Palo Alto, CA (US)

(21) Appl. No.: 12/753,829

(22) Filed: Apr. 2, 2010

(51) Int. Cl. G06Q 30/00; G09G 5/00; G06Q 10/00; G06F 3/048

(52) U.S. Cl. 705/14.24; 345/633; 705/14.25; 705/14.36; 715/764

(57) ABSTRACT

Disclosed are a system, method, and article of manufacture for augmented-reality marketing with a virtual coupon. A virtual representation of an object is provided. A real representation of the object is provided. An association of the virtual representation and the real representation is rendered with a user interface. A virtual coupon is made available to a user when the virtual representation and the real representation are rendered. A graphical metaphor may be integrated into the virtual representation according to an environmental characteristic of the object. The environmental characteristic may include a physical environmental characteristic, a data environmental characteristic, a computer environmental characteristic or a user environmental characteristic.

### FIELD OF TECHNOLOGY

This disclosure relates generally to a communication system, and, more particularly, to a system, a method and an article of manufacture of augmented-reality marketing with a virtual coupon.

### BACKGROUND

Augmented reality (AR) can create the illusion that computer-generated virtual objects (such as models, icons, animations, game entities, etc.) exist in the real world. For example, user can “see through” a smart phone touchscreen to view both the real world as captured by the lens of a camera and added virtual objects. A common example of this is the overlaying of 2D or 3D virtual objects on digital videos. Moreover, in the case of 3D virtual objects, the user can move and see the virtual object from different angles as the AR system aligns the real and virtual cameras automatically.

Accordingly, AR technology can enhance a user's experience of a viewed real object. This enhancement value has recently led to the incorporation of AR systems into sales strategies used by some vendors. However, these sales strategies merely utilize a predetermined static virtual object. The static virtual objects do not change attributes as the real world changes in real-time. Consequently, much of the potential value of AR technology in marketing remains underutilized.

### SUMMARY

A system, method, and article of manufacture for augmented-reality marketing with virtual coupon are disclosed. In one aspect, a virtual representation of an object is provided. A real representation of the object is provided. An association of the virtual representation and the real representation is rendered with a user interface. A virtual coupon is made available to a user when the virtual representation and the real representation are rendered.

In another aspect, a sensor data pertaining to an entity is provided. A graphical metaphor of the sensor data is generated. A virtual representation of the entity is provided. The virtual representation includes the graphical metaphor. A digital representation of the entity is generated as perceived through the lens of a digital camera. The virtual representation and the digital representation of the entity are rendered with a user interface.

In yet another aspect, a computer system is provided. A user interface on the computer system is provided. An image of an object rendered by the user interface is augmented with a virtual element. A credit application is launched if the image of the object is augmented with the virtual element.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a block diagram showing a schematic view of an example augmented-reality marketing with a smart device system according some embodiments.

FIG. 2 is a block diagram showing an exemplary computing environment in which the technologies described herein can be implemented accordance with one or more embodiments.

FIG. 3 shows a simplified block diagram of a portable electronic device constructed and used in accordance with one or more embodiments.

FIG. 4 shows a schematic view of an illustrative display screen according to one or more embodiments.

FIG. 5 shows a schematic view of an illustrative display screen according to one or more embodiments.

FIG. 6 shows a schematic view of an illustrative display screen according to one or more embodiments.

FIG. 7 shows a flowchart of an illustrative process for augmented reality marketing in accordance with one embodiment.

FIG. 8 shows a flowchart of another illustrative process augmented reality marketing in accordance with another embodiment.

Other features of the present embodiments will be apparent from the accompanying drawings and from the detailed description that follows.

### DETAILED DESCRIPTION

Disclosed are a system, method, and article of manufacture for augmented-reality marketing with a virtual coupon. Although the present embodiments have been described with reference to specific example embodiments, it will be evident that various modifications and changes can be made to these embodiments without departing from the broader spirit and scope of the various claims.

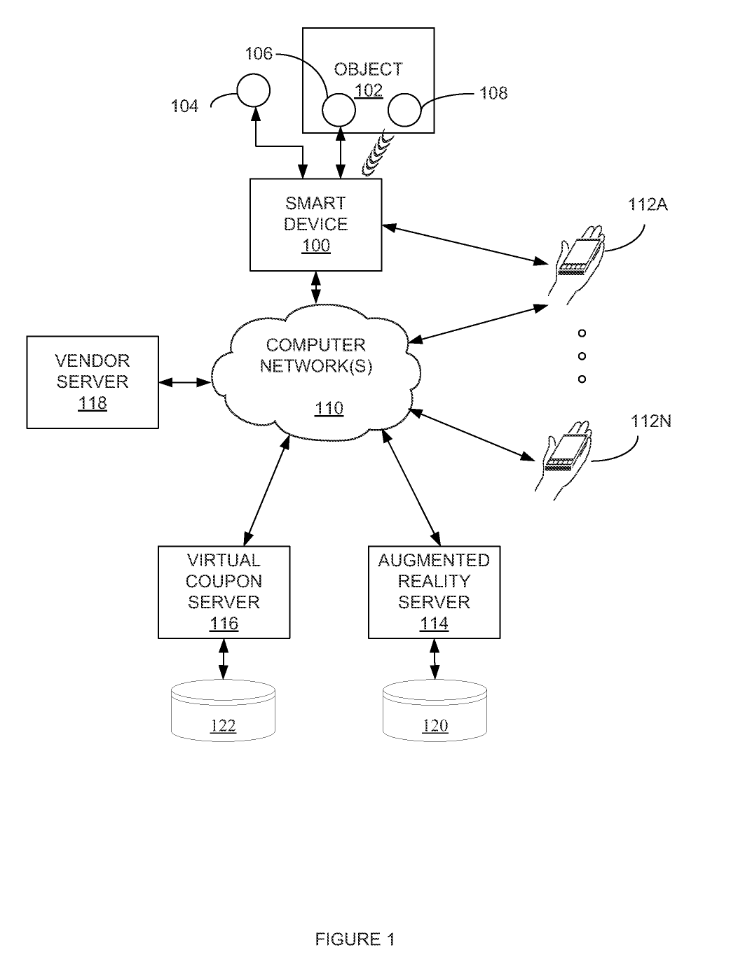

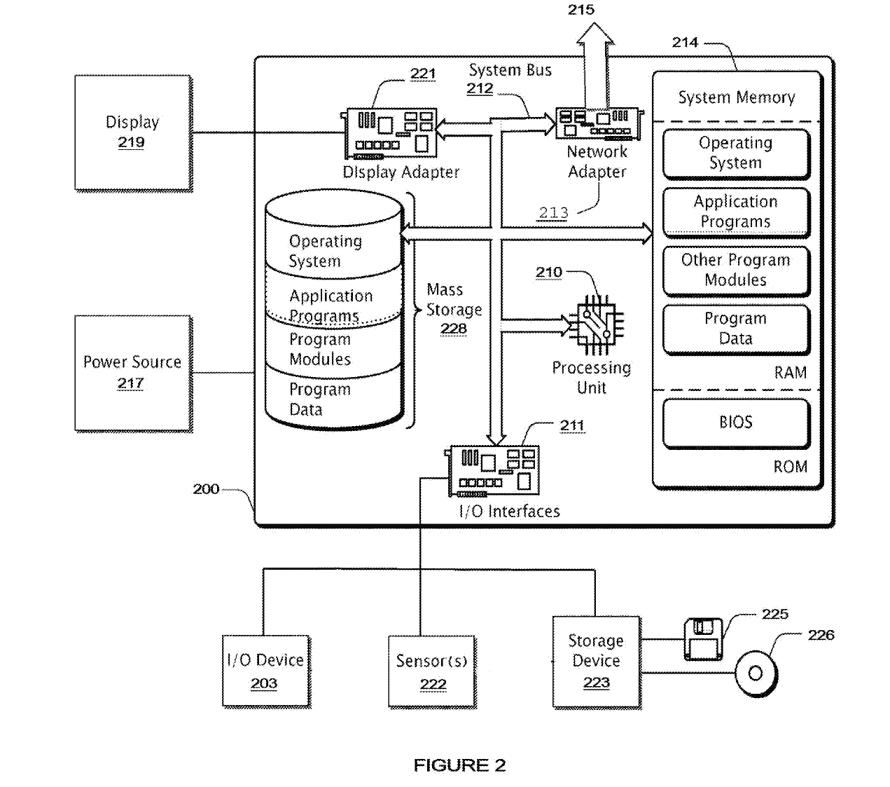

FIG. 1 is a block diagram showing a schematic view of an example augmented-reality marketing with a smart device system according to some embodiments. A smart device 100 is typically coupled with one or more sensors 104-108. Generally, a smart device 100 can be a computerized device capable of coupling with a computer network. The complexity of the smart device 100 can vary with the object 102 and environment it is designed to monitor. However, the smart device may be any computing environment described in connection with FIG. 2. Typically, smart device 100 can be a simple computer scaled to centimeter dimensions. As such, the smart device 100 can be coupled and portable with many physical objects in a user's environment in an unobtrusive manner. Generally, a smart device 100 includes a processor, networking interface, at least one sensor, and a power source. A smart device 100 can also include a radio frequency identification (RFID) and/or near field communication (NFC) device. An example RFID device can include a RFID device printed in carbon nanotube ink on a surface of the object 102.

It should be noted that FIG. 1 shows a single smart device for purposes of clarity and illustration. Accordingly, certain embodiments can include a number of smart devices 100. These smart devices 100 may be networked to form a smart environment. According to various embodiments, a smart environment (e.g. a set of smart devices interactively coupled through a computer network) may be associated with a particular physical appliance, location, building and/or user. In one embodiment, a smart environment can aggregate data from individual member smart devices and interact with a user such that it appears as a single device from the user's perspective. Smart device 100 can also identify the object 102 for a server such as the AR server 114.

Typically, a sensor 104-108 can be a device that measures an attribute of a physical quantity and converts the attribute into a user-readable or computer-processable signal. In certain embodiments, a sensor 104-108 can also measure an attribute of a data environment, a computer environment and a user environment in addition to a physical environment. For example, in another embodiment, a sensor 104-108 may also be a virtual device that measures an attribute of a virtual environment such as a gaming environment. By way of example and not of limitation, FIG. 1 shows a single smart device 100 with three sensors 104-108. Sensor 104 can measure an environmental attribute of the physical environment of object 102. Sensors 106 and 108 can measure attributes of the object 102. A sensor 104-108 can communicate with the smart device 100 via a physically (e.g. wired) and/or wireless (e.g. Bluetooth™, ISO/IEC 14443 implemented signal) connection according to the various characteristics of the smart device 100 and/or the object 102.

FIG. 1 further illustrates a smart device 100 communicatively coupled with portable electronic devices 112A-112N, according to one embodiment. The smart device 100 can communicatively couple with the electronic devices 112A-112N either directly and/or via one or more computers network(s) 110. Portable electronic devices 112A-112N can be implemented in or as any type of portable electronic device or devices, such as, for example, the portable electronic device of 300 and/or the computing device 200 discussed infra.

Computer network(s) 110 can include any suitable circuitry, device, system or combination of these (e.g., a wireless communications infrastructure including communications towers and telecommunications servers) operative to create a computer network can be used to create computer network(s) 110. Computer network(s) 110 may be capable of providing wireless communications using any suitable short-range or long-range communications protocol. In some embodiments, computer network(s) 110 can support, for example, Wi-Fi (e.g., an 802.11 protocol), Bluetooth™, high frequency systems (e.g., 900 MHz, 2.4 30 GHz, and 5.6 GHz communication systems), infrared, other relatively localized wireless communication protocols, such as RFID and NFC, or any combination thereof.

In some embodiments, computer network(s) 110 can support protocols used by wireless and cellular phones and personal email devices (e.g., a smart phone). Such protocols can include, for example, GSM, GSM plus EDGE, CDMA, UMTS, quadband, and other cellular protocols. In another example, a long-range communications protocol can include Wi-Fi and protocols for placing or receiving calls using VOIP or LAN. Furthermore, in some embodiments, computer network(s) 110 can include an interne protocol (IP) based network such as the Internet. In this way, the devices of FIG. 1 can transfer data between each other as well as with other computing devices (e.g. third party servers and databases) not shown for the purposes of clarity.

Additionally, FIG. 1 illustrates an augmented reality (AR) server 114, a virtual coupon server 116, and a vendor server 118 communicatively coupled with each other as well as the smart device and/or the portable electronic devices 112A-N. The AR server 114 includes hardware and/or software functionalities that generate a virtual representation of the object 102. The AR server 114 can be communicatively coupled with a database 120 that includes user data, object data and object environmental data. Database 120 can also include AR marker data as well as a image pattern database used to identify particular objects. In some embodiments, the AR server 114 can obtain user data from the vendor server 118. For example, the vendor server 118 can be managed by a commercial entity that provides goods and/or services. A user can utilize a platform supported by the vendor server 118 to enroll in an incentive program that enables the user to receive virtual coupons from the commercial entity. During registration the user can provide demographic and other relevant marketing information. The AR server 114 can obtain object data and object environmental data from the smart device 100. The AR server 114 can generate a virtual representation of the object 102. In one embodiment, portions of the virtual representation can also be derived from a database of pre-designed graphical representations associated with an AR marker detected on the object 102.

In some embodiments, user location data can also be utilized to determine an element of the virtual representation. User location data can be determined with such devices as of a global positioning system (GPS) receiver, a RF triangulation detector, and a RF triangulation sensor. For example, location data can be utilize to determine the language of text elements of the virtual representation. In another example, location data can be used to determine cultural and/or geographical relevant icons into the virtual representation.

In some embodiments, the AR server 114 can modify elements of the virtual representation to include graphical metaphors of information pertaining to the object data, object environmental data (e.g. obtained from the smart device 100), user data and/or any combination thereof. The graphical metaphors can communicate certain values of the object variables and can be designed to utilize specific knowledge that a user already has of another domain.

For example, a food item might include an expiration variable. The smart device 100 can provide time until expiration data to the AR server 114. The AR server 114 can then provide a virtual representation of the food item (e.g. schematic, symbolic, realistic, etc.). An element of this virtual representation such as the color can be modified to provide a graphical metaphor of the time until expiration data. For example, the color of the virtual representation could darken as a function of time until expiration. A symbolic graphical metaphor such as a symbol for poison or a text warning can also be integrated into the virtual representation after a certain period of time. The virtual representation and concomitant graphical metaphor elements can be rendered as instructions to a user interface of the portable electronic device. In one embodiment, AR server 114 can be implemented as the computing device 200 of FIG. 2 infra. In some embodiments, the functionalities of the AR server 114 can be integrated into the portable electric device 112A-N.

It should be noted that in some embodiments, virtual representations may not be limited to graphical representations rendered by a graphical user interface (GUI). Other examples of possible non-graphical representations include audio representations and haptic representations. In such cases, graphical metaphors can be rendered as sounds or haptic signal patterns. Furthermore, in some embodiments, virtual representations may include multiple virtual objects. For example, each virtual object can include one or more graphical metaphors representing multiple sensory and/or object historical data.

In some embodiments, AR server 114 can also can use one or more pattern recognition algorithms to compare the object detected by a portable electronic device 112A-N with images in an identification database. For example, suitable types of pattern recognition algorithms can include neural networks, support vector machines, decision trees, K-nearest neighbor, Bayesian networks, Monte Carlo methods, bootstrapping methods, boosting methods, or any combination thereof.

Virtual coupon server 116 includes hardware and/or software functionalities that generate a virtual coupon. The virtual coupon can then be communicated to a portable electronic device such as 112A and/or the vendor server 118. In one embodiment, the AR server 114 can communicate an instruction to the virtual coupon server 116 when the AR server communicates a virtual representation to the portable electronic device 112A. Virtual coupon server 116 can modify elements of the virtual coupon to include graphical metaphors of information pertaining to the object data and/or object environmental data obtained from the smart device 100. In other embodiments, virtual coupon server 116 can modify elements of the virtual coupon to also include user data and/or vendor data. The value of a virtual coupon can be determined according to several factors such as sensor data, vendor inventory data and/or user state data, object data or any combination thereof. User data, object data and object environmental data can be obtained from the vendor server 118, database 120, sensors 104-108 via the smart device 100 and/or the portable electronic devices 112A-N, or any combination thereof. The data can be stored in database 122. In some embodiments, the rendering of a virtual coupon can be integrated into the virtual representation of the object.

In some embodiments, the virtual coupon server 116 can mediate virtual coupon redemption between a user of a portable electronic device and the vendor server 118. In some embodiments, virtual coupon server 116 can enable redemption of virtual coupons at a vendor location. For example, a user of a portable electronic device can use a output device (e.g. using RFID, Bluetooth™) of the portable electronic device to communicate possession of virtual coupon codes provided by virtual coupon server 116 to a virtual coupon redemption device (e.g. implemented with computing device 200) at the vendor location. Vendor's virtual coupon redemption device can then verify the validity of the codes with the virtual coupon server 116. In some embodiments, the virtual coupon server 116 can enable payments and money transfers to be made through the computer network(s) 110 (for example via the Internet).

In some embodiments, virtual coupon server 116 can determine a value of the virtual coupon based upon third-party data and/or such considerations as such as a user's (e.g. a user of a portable electronic device 112A-N) bank account value, a user's location, a user's purchasing history a vendor's inventory and/or any combination thereof. For example, a user may have included access to user-related databases (e.g. banking data, purchasing history data, demographic data, portable electronic device data) to the vendor server 118 when the user, enrolled in a vendor's AR marketing system. The vendor server 118 can then provide this information to the virtual coupon server 116. The vendor server 118 can also provide vendor data to the virtual coupon server 116. For example, the vendor server 118 can periodically update the vendor's inventory data on the database 122.

In some embodiments, the virtual coupon server 116 can query the vendor server 118 when rendering a virtual coupon. The query can include real-time information about the user such as user's present state, location and/or recently acquired context data from the user's portable electronic device 112A-N. Accordingly, the vendor server 118 can include this information in an operation to determine a virtual coupon value. The vendor server 118 can then communicate a virtual coupon value to the virtual coupon server 116, whereupon the virtual coupon server 116 can render a new virtual coupon. In this way, in some embodiments, a vendor can determine the value of the virtual coupon.

In some embodiments, the virtual coupon server 116 can modify the value of a virtual coupon and/or how it is rendered with a user interface in real-time (assuming processing and transmission latency). For example, a virtual coupon can first be rendered as a graphical element on a portable electronic device display. The portable electronic device 112A-N can automatically update (periodically and/or in real-time) certain user and/or portable electronic device 112A-N related data to the various server's of FIG. 1. Thus, for example, if the user begins moving at a specified velocity (e.g. driving), the virtual coupon server 116 can then render the virtual coupon as an audio message. In some embodiments, the virtual coupon server 116 can change a value of a virtual coupon if user does not accept a virtual coupon offer within a predetermined period.

In some embodiments, the vendor server 118 can communicate an instruction to the AR server 114 and/or a portable electronic device 112A-N to modify a real or virtual representation of an object. The instruction can be based in whole or in part upon third-party data and/or such considerations such as a user's bank account value, a user's location, a user's purchasing history, a vendor's inventory and/or any combination thereof.

In some embodiments, the functionalities of the vendor server 118 and the virtual coupon server 116 can be implemented by one or more applications operating on a single server. Furthermore, in some embodiments, the functionalities of the vendor server 118, the virtual coupon server 116 and the AR server 114 can be implemented by one or more applications operating on a single server and/or a portable electronic device 112A-N. For example, a portable electronic device 112A-N can perform the functionalities of the servers of FIG. 1 at certain times, and then offload a portion of the workload to a server in order to scale processing and memory resources. In some embodiments, the functionalities of the vendor server 118, the virtual coupon server 116 and the AR server 114 can implemented in a cloud-computing environment and accessed by a client application residing on the portable electronic device 112A-N. Indeed, it should be noted that, in some embodiments, any of the various functionalities of the devices and modules of FIGS. 1-3 can be implemented and/or virtualized in a cloud-computing environment and accessed by a thin client residing on the portable electronic device 112A-N.

FIG. 2 is a block diagram showing an exemplary computing environment in which the technologies described herein can be implemented accordance with one or more embodiments. A suitable computing environment can be implemented with numerous general purpose or special purpose systems. Examples of well-known systems can include, but are not limited to, smart devices, microprocessor-based systems, multiprocessor systems, servers, workstations, and the like.

Computing environment typically includes a general-purpose computing system in the form of a computing device 200 coupled to various components, such as peripheral devices 223, 225, 226 and the like. Computing device 200 can couple to various other components, such as input devices 206, including voice recognition, touch pads, buttons, keyboards and/or pointing devices, such as a mouse or trackball, via one or more input/output (“I/O”) interfaces 211. The components of computing device 200 can include one or more processors (including central processing units (“CPU”), graphics processing units (“GPU”), microprocessors (“IJP”), and the like) 210, system memory 214, and a system bus 212 that typically couples the various components. Processor 210 typically processes or executes various computer-executable instructions to control the operation of computing device 200 and to communicate with other electronic and/or computing devices, systems or environment (not shown) via various communications connections such as a network connection 215 or the like. System bus 212 represents any number of several types of bus structures, including a memory bus or memory controller, a peripheral bus, a serial bus, an accelerated graphics port, a processor or local bus using any of a variety of bus architectures, and the like.

System memory 214 can include computer readable media in the form of volatile memory, such as random access memory (“RAM”), and/or nonvolatile memory, such as read only memory (“ROM”) or flash memory (“FLASH”). A basic input/output system (“BIOS”) can be stored in non-volatile or the like. System memory 214 typically stores data, computer-executable instructions and/or program modules comprising computer-executable instructions that are immediately accessible to and/or presently operated on by one or more of the processors 210. Mass storage devices 223 and 228 can be coupled to computing device 200 or incorporated into computing device 200 via coupling to the system bus 212. Such mass storage devices 223 and 228 can include non-volatile RAM, a magnetic disk drive which reads from and/or writes to a removable, non-volatile magnetic disk 225, and/or an optical disk drive that reads from and/or writes to a non-volatile optical disk such as a CD ROM, DVD ROM 226. Alternatively, a mass storage device 228, such as hard disk 228, can include non-removable storage medium. Other mass storage devices 228 can include memory cards, memory sticks, tape storage devices, and the like. Mass storage device 228 can be remotely located from the computing device 200.

Any number of computer programs, files, data structures, and the like can be stored in mass storage 228, other storage devices 223, 225, 226 and system memory 214 (typically limited by available space) including, by way of example and not limitation, operating systems, application programs, data files, directory structures, computer-executable instructions, and the like.

Output components or devices, such as display device 219, can be coupled to computing device 200, typically via an interface such as a display adapter 221. Output device 219 can be a liquid crystal display (“LCD”). Other example output devices can include printers, audio outputs, voice outputs, cathode ray tube (“CRT”) displays, tactile devices or other sensory output mechanisms, or the like. Output devices can enable computing device 200 to interact with human operators or other machines, systems, computing environments, or the like. A user can interface with computing environment via any number of different I/O devices 203 such as a touch pad, buttons, keyboard, mouse, joystick, game pad, data port, and the like. These and other I/O devices 203 can be coupled to processor 210 via I/O interfaces 211 which can be coupled to system bus 212, and/or can be coupled by other interfaces and bus structures, such as a parallel port, game port, universal serial bus (“USB”), fire wire, infrared (“IR”) port, and the like.

The computing environment of FIG. 2 can also include sensor(s) 222. Example sensor(s) 222 include, inter alia, include a: GPS, accelerometer, inclinometer, position sensor, barometer, WiFi sensor, radio-frequency identification (RFID) tag reader, gyroscope, pressure sensor, pressure gauge, time pressure gauge, torque sensor, infrared image capture device, ohmmeter; thermometer, microphone, image sensor (e.g. digital cameras), biosensor (e.g. photometric biosensor, electrochemical biosensor), capacitance sensor, radio antenna, augmented reality camera, capacitance probe, proximity card reader, electronic product code reader, any other detection technology, or any combination thereof. It should be noted that the other sensor devices other than those listed can also be utilized to sense context information.

Computing device 200 can operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 200 can be coupled to a network via network adapter 213 or the like, or, alternatively, via a modem, digital subscriber line (“DSL”) link, integrated services digital network (“ISDN”) link, Internet link, wireless link, or the like.

Communications connections, such as a network connection 215, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media can include wired media, such as a wired network or direct-wired connection or the like, and wireless media, such as acoustic, radio frequency, infrared, or other wireless communications mechanisms.

Power source 217, such as a battery or a power supply, typically provides power for portions or all of computing environment. In the case of the computing environment being a mobile device or portable device or the like, power source 217 can be a battery. Alternatively, in the case that the computing environment is a smart device or server or the like, power source 217 can be a power supply designed to connect to an alternating current (AC) source, such as via a wall outlet. Although the smart device 100 can run on another power source (e.g. battery, solar) that is appropriate to the particular context of the object 102.

Some computers, such as smart devices, may not include several of the components described in connection with FIG. 2. For example, a smart device may not include a user interface. In addition, an electronic badge can be comprised of a coil of wire along with a simple processing unit 210 or the like, the coil configured to act as power source 217 when in proximity to a card reader device or the like. Such a coil can also be configure to act as an antenna coupled to the processing unit 210 or the like, the coil antenna capable of providing a form of communication between the electronic badge and the card reader device. Such communication may not involve networking, but can alternatively be general or special purpose communications via telemetry, point-to-point, RF, infrared, audio, or other means. An electronic card may not include display 219, I/O device 203, or many of the other components described in connection with FIG. 2. Other devices that may not include some of the components described in connection with FIG. 2, include electronic bracelets, electronic tags, implantable devices, computer goggles, other body-wearable computers, smart cards and the like.

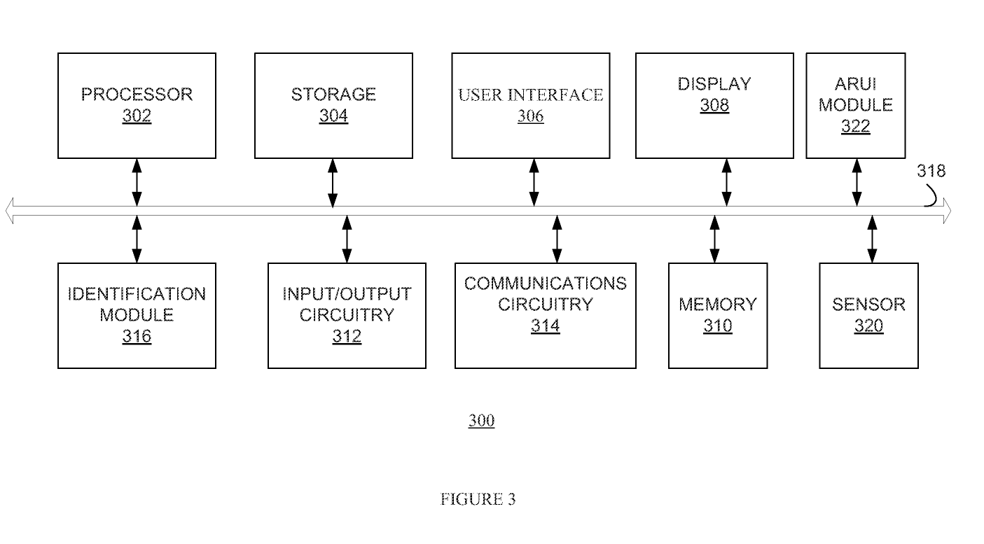

FIG. 3 shows a simplified block diagram of a portable electronic device 300 constructed and used in accordance with one or more embodiments. In some embodiments, portable electronic device 300 can be a portable computing device dedicated to processing multi-media data files and presenting that processed data to the user. For example, device 300 can be a dedicated media player (e.g., MP3 player), a game player, a remote controller, a portable communication device, a remote ordering interface, a tablet computer or other suitable personal device. In some embodiments, portable electronic device 300 can be a portable device dedicated to providing multi-media processing and telephone functionality in single integrated unit (e.g. a smart phone).

Portable electronic device 300 can be battery-operated and highly portable so as to allow a user to listen to music, play games or videos, record video or take pictures, place and take telephone calls, communicate with other people or devices, control other devices, and any combination thereof. In addition, portable electronic device can be sized such that it fits relatively easily into a pocket or hand of the user. By being handheld, portable electronic device is relatively small and easily handled and utilized by its user and thus can be taken practically anywhere the user travels.

Portable electronic device 300 can include processor 302, storage 304, user interface 306, display 308, memory 310, input/output circuitry 312, communications circuitry 314, identification module 316, and/or bus 318. In some embodiments, portable electronic device 300 can include more than one of each component or circuitry, shown in FIG. 3, but for the sake of clarity and illustration, only one of each is shown in FIG. 3. In addition, it will be appreciated that the functionality of certain components and circuitry can be combined or omitted and that additional components and circuitry, which are not shown in FIG. 3, can be included in portable electronic device 300.

Processor 302 can include, for example, circuitry for and be configured to perform any function. Processor 302 can be used to run operating system applications, media playback applications, media editing applications, and/or any other application. Processor 302 can drive display 308 and can receive user inputs from user interface 306.

Storage 304 can be, for example, one or more storage mediums, including for example, a hard-drive, flash memory, permanent memory such as ROM, semipermanent memory such as RAM, any other suitable type of storage component, or any combination thereof. Storage 304 can store, for example, media data (e.g., music and video files), application data (e.g., for implementing functions on device 200), firmware, preference information data (e.g., media playback preferences), lifestyle information data (e.g., food preferences), exercise information data (e.g., information obtained by exercise monitoring equipment), transaction information data (e.g.; information such as credit card information), wireless connection information data (e.g., information that can enable device 200 to establish a wireless connection), subscription information data (e.g., information that keeps track of podcasts or television shows or other media a user subscribes to), contact information data (e.g., telephone numbers and email addresses), calendar information data, any other suitable data, or any combination thereof.

User interface 306 can allow a user to interact with portable electronic device 300. For example, the device for user interface 306 can take a variety of forms, such as at least one a button, keypad, dial, a click wheel, a touch screen or any combination thereof.

Display 308 can accept and/or generate signals for presenting media information (textual and/or graphic) on a display screen, such as those discussed above. For example, display 308 can include a coder/decoder (CODEC) to convert digital media data into analog signals. Display 308 also can include display driver circuitry and/or circuitry for driving display driver(s). The display signals can be generated by processor 302 or display 308. The display signals can provide media information related to media data received from communications circuitry 314 and/or any other component of portable electronic device 300. In some embodiments, display 308, as with any other component discussed herein, can be integrated with and/or externally coupled to portable electronic device 300.

Memory 310 can include one or more different types of memory which can be used for performing device functions. For example, memory 310 can include cache, Flash, ROM, RAM, or one or more different types of memory used for temporarily storing data. Memory 310 can be specifically dedicated to storing firmware. For example, memory 310 can be provided for storing 30 firmware for device applications (e.g., operating system, user interface functions, and processor functions).

Input/output circuitry 312 can convert (and encode/decode, if necessary) data, analog signals and other signals (e.g., physical contact inputs, physical movements, analog audio signals, etc.) into digital data, and vice-versa. The digital data can be provided to and received from processor 302, storage 304, and memory 310, or any other component of portable electronic device 300. Although input/output circuitry 312 is illustrated in FIG. 3 as a single component of portable electronic device 300, a plurality of input/output circuitry can be included in portable electronic device 300. Input/output circuitry 312 can be used to interface with any input or output component, such as those discussed in connection with FIGS. 1 and 2. For example, portable electronic device 300 can include specialized input circuitry associated with input devices such as, for example, one or more microphones, cameras, proximity sensors, accelerometers, ambient light detectors, magnetic card readers, etc. Portable electronic device 300 can also include specialized output circuitry associated with output devices such as, for example, one or more speakers, etc.

Communications circuitry 314 can permit portable electronic device 300 to communicate with one or more servers or other devices using any suitable communications protocol. For example, communications circuitry 314 can support Wi-Fi (e.g., a 802.11 protocol), Ethernet, Bluetooth™ (which is a trademark owned by Bluetooth Sig, Inc.) high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. The portable electronic device 300 can include a sensor. Example sensors include those discussed supra in the description of FIG. 2.

Identification module 316 can utilize sensors for detecting and identifying objects. The identification module 316 can use any suitable pattern recognition algorithms to identify objects. In some embodiments, identification module 316 can activate a RFID tag reader that is operative for detecting RFID tags that are located on objects. Identification module 316 can be operative to read passive, active, and/or semi-passive RFID tags. For example, while the user is looking at objects in a refrigerator such as milk cartons and other food containers, identification module 316 can activate the RFID tag reader to read passive RFID tags. In response to the activation, the RFID tag reader can generate a query to passive RFID tags that are attached to objects. The RFID tags can respond to the query by generating radio frequency signals back to the RFID reader. In another embodiment, another short-range wireless communication technology which enables the exchange of data between devices such as near-field communication (NFC) technology can be utilized in lieu or in combination with RFID tags. In other example embodiments, the identification module 316 can utilize an AR marker (such as a pattern on the object's surface or a light-emitting diode signal) of the object to determine a virtual representation of an object.

Additionally, identification module 316 can query a server or database to determine additional information about an object such as historical data about the object, marketing data about the object and/or object state data. For example, a smart device attached to and/or associated with the object can upload object identification and object state data to the server. Identification module 316 can perform an initial identity determination operation to determine an identity (e.g. from an RFID tag). Identification module 316 can then utilize this identity to query the server to obtain the information uploaded by the smart device associated with the object. In an example embodiment, a query by the identification module 316 can initiate a server-side operation to update the information about the object (e.g. query the smart device associated with the object) prior to responding to the identification module's query.

Additionally, in one embodiment, identification module 316 can query a server or database to obtain a virtual representation of an object. Augmented-reality user interface (ARUI) module 322 can integrate the virtual representation of the object into a digital image of the object and/or the object's environment. ARUI module 322 can also utilize marker AR, markerless AR or a combination thereof to determine how to augment a digital image.

In one embodiment, ARUI module 322 can utilize an AR marker tags physically incorporated into the real object. ARUI module 322 uses the marker tags to determine the viewpoint of the digital camera so a virtual representation can be rendered appropriately. It should be noted that a virtual representation generated from marker tags can be modified according to information obtained from a smart device associated with the object. Exemplary marker AR systems include, inter alia, fiducial marker systems such as ARTag.

Another embodiment can use markerless AR. ARUI module 322 can track the location of the virtual representation to the physical representation of the object with a markerless AR system. The ARUI module 322 can use image registration and/or image alignment algorithms to track the virtual representation to the physical representation. For example, an image registration algorithm can spatially transform the virtual representation to align with the physical representation. By way of illustration, other markerless AR methods that can be utilized such as fingertip tracking or hand gesture recognition markerless AR techniques.

In one embodiment, an object's virtual representation can include both standardized and modifiable elements. The modifiable elements of the virtual representation can be adapted to incorporate information about the object such the object's state. For example, a smart device attached to a carton of milk uses a weight sensor to detect that the carton is half-full. The smart device uploads this information to the server. The server generates a virtual image of the carton of milk including a representation of how full the carton is with milk. This virtual representation is then communicated to the ARUI module 322. The ARUI module 322 then renders the virtual representation to overlay a physical representation of the carton rendered by the user interface. If milk were to be poured into the carton, the smart device can update the object state data relative to amount of added milk. The server can then generate an updated virtual representation that is then communicated to the ARUI module 322. The ARUI module 322 can then update the rendering the virtual representation of the object. A user can view the adding of the milk to the cartoon in near real-time (assuming such issues as network and processing latency). Historical data can also be incorporated into the virtual representation. For example, a color of the virtual representation of the carton can be modified by degrees as the milk nears an expiration date. These examples have been provided for the sake of clarity and illustration, other modifications of the virtual image can be implemented according to various other types of information obtained about the object and the object's environment. It should also be noted that in certain embodiments, the object's environment may not be limited to the object's physical environment. Certain objects can include a data environment, a computer environment and a user environment as well. The ARUI module 322 can include an application programming interface (API) to enable interaction with the AR server 114.

Bus 318 can provide a data transfer path for transferring data to, from, or between processor 302, storage 304, user interface 306, display 308, memory 310, input/output circuitry 312, communications circuitry 314, identification module 316, sensor 320 and ARUI module 322.

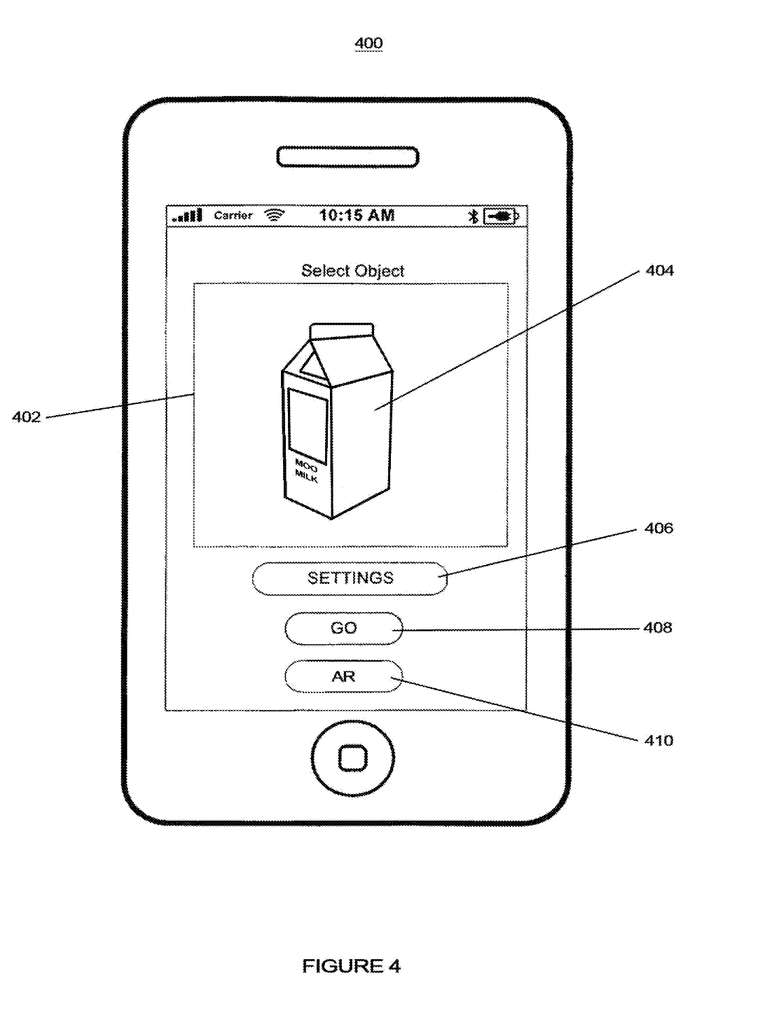

FIG. 4 shows a schematic view of an illustrative display screen according to one or more embodiments. Display 400 can include identification screen 402. In some embodiments, identification screen 402 can include images as seen through a digital camera lens. The user can use identification screen 402 to locate one or more objects 404 to be identified. For example, the user can orient the portable electronic device 112A-N to capture an image of a milk carton 404. The portable electronic device 112A-N can detect the RFID device in the milk carton 404. In some embodiments, identification screen 402 can include messages for using the portable electronic device to detect object 404 that includes RFID tags. An example of a message such as “Select GO to identify objects” can be displayed on the identification screen 402 when the RFID tag is detected. A user can select the “GO” virtual button 408 to select the milk carton 404. The display screen 400 can include an “AR” virtual button 410. Once the milk carton 404 has been selected, the user can select the AR virtual button 410 to initiate an operation to query the AR server to obtain a virtual representation of the milk carton 404.

In some embodiments, display screen 400 can include “SETTINGS” virtual button 406. In response to the user selecting “SETTINGS” virtual button 406, the portable electronic device 112A-N can provide additional options to the user such as display configurations, virtual coupon storage (discussed infra) and redemption options and/or object selection options.

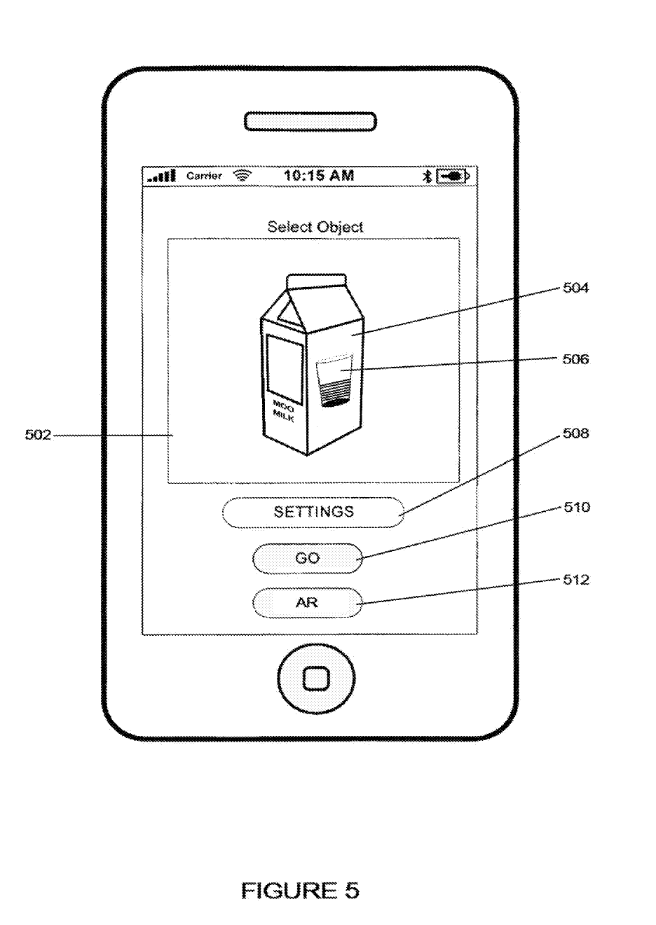

FIG. 5 shows a schematic view of an illustrative display screen according to one or more embodiments. Display 500 can include identification screen 502. In some embodiments, identification screen 502 can include an image, such as the milk carton 504, as seen through a digital camera lens and a virtual representation 506 of the milk carton 504. The virtual representation 506 of the milk carton 504 can be rendered with the display 500. In one embodiment, the virtual representation 506 can overlay the image of the milk carton 504. The virtual representation can be modified to include graphical metaphor of information obtained from a sensor. For example, FIG. 5 shows the virtual representation 506 as a cylinderlike semitransparent object. In this example, the virtual representation 506 is an abstraction of the function of the milk carton 504. However, in other embodiments, a virtual representation can be rendered in a more realistic manner. A graphical metaphor included as an element of the virtual object 506 can rendered as a less transparent portion of the cylinderlike semitransparent object as shown in FIG. 5. The graphical metaphor element can correspond to a value measured by a weight sensor. The value can approximate the level of milk remaining the milk carton 504. In some embodiments, the level of the less transparent portion can modulate in real time in accordance with a change in amount of milk currently in the milk carton 504 (assuming networking and processing latency).

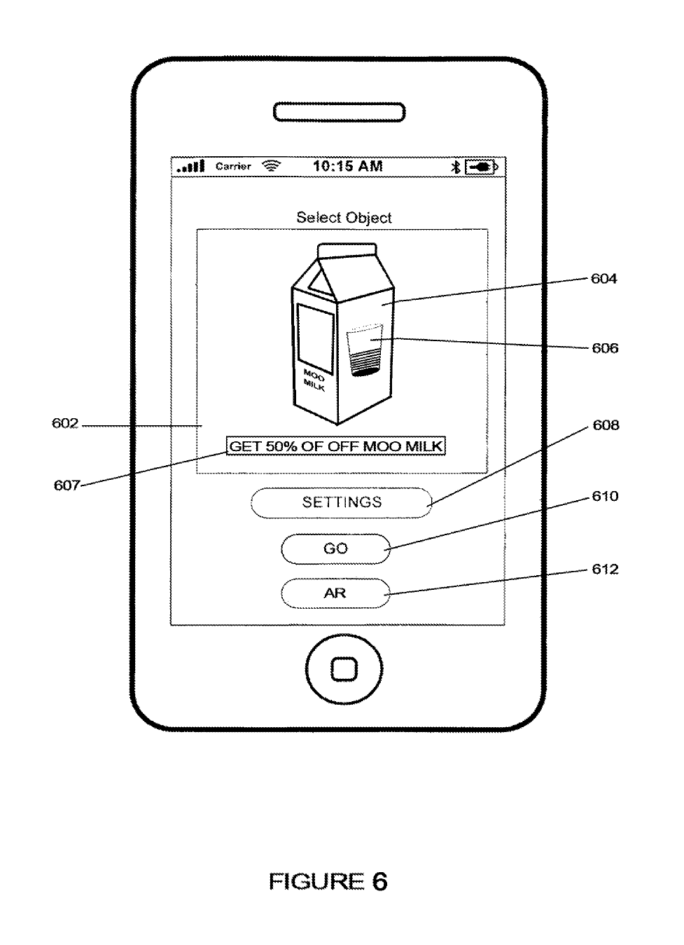

FIG. 6 shows a schematic view of an illustrative display screen according to one or more embodiments. Display 600 can include identification screen 602. In some embodiments, identification screen 602 can include an image, such as the milk carton 604, as seen through a digital camera lens, a virtual representation 606 of the milk carton 604 and a virtual coupon 607. A hyperlink can be embedded in the virtual coupon 607. In one embodiment, the hyperlink can reference a World Wide Web document. In another embodiment, the hyperlink can reference a virtual world network supported by a platform such as OpenSimulator and Open Cobalt. Typically, the hyperlink destination enables the user to redeem or save the virtual coupon.

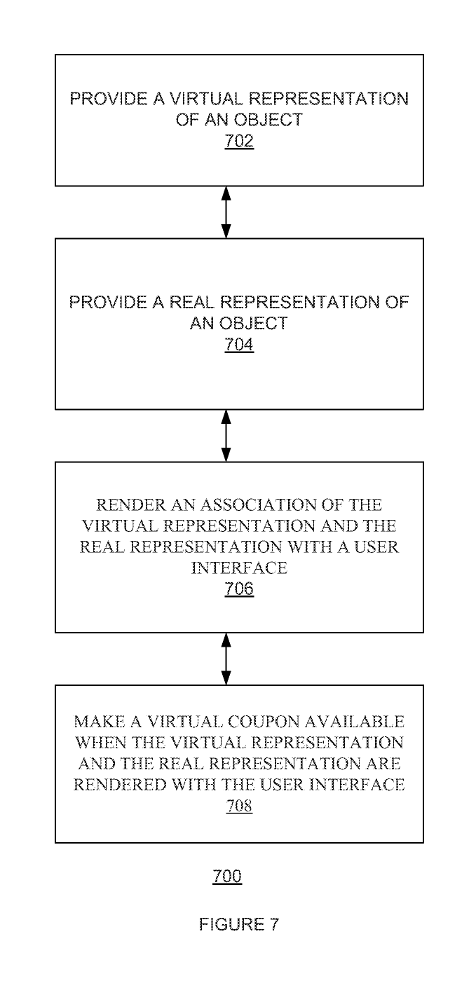

FIG. 7 shows a flowchart of an illustrative process 700 for augmented reality marketing in accordance with one embodiment. Block 702 typically indicates providing a virtual representation of an object. The virtual representation of the object can be provided by the AR server 114. For example, in some embodiments, the AR server 114 can identify the real representation of the object using a one or more pattern recognition algorithms. In some embodiments, the AR server 114 can match the real algorithm with a pre-associated virtual representation. For example, the AR server 114 can include a utility that accesses a relational database or simple table to determine the association. In other embodiments, the virtual representation can be determined from an AR marker image obtained by the portable electronic device and communicated to the AR server 114.

Block 704 typically indicates providing a real representation of the object, typically via a camera such as that describe in FIGS. 2 and 3 supra. For example, a camera of a portable electronic device of FIG. 3 can acquire a digital image of an object with digital camera included in the input/output circuitry 312. In some embodiments, the portable electronic device can provide digital image to the AR server 114.

Block 706 typically indicates rendering an association of the virtual representation and the real representation with a user interface. Typically, the rendering of the association can be performed by generating a set of instructions for a user interface such as the user interface 306. For example, if the instructions are generated by the AR server 114, the instruction can then be communicated to the user interface of the portable electronic device 112A via the computer network(s) 110.

Block 708 typically indicates making a virtual coupon available to a user when the virtual representation and the real representation are rendered with the user interface. For example, in some embodiments, the virtual coupon can be made available upon an instruction from the AR server 114. The virtual coupon server 116 can receive the instruction and provide the virtual coupon according to the instructions.

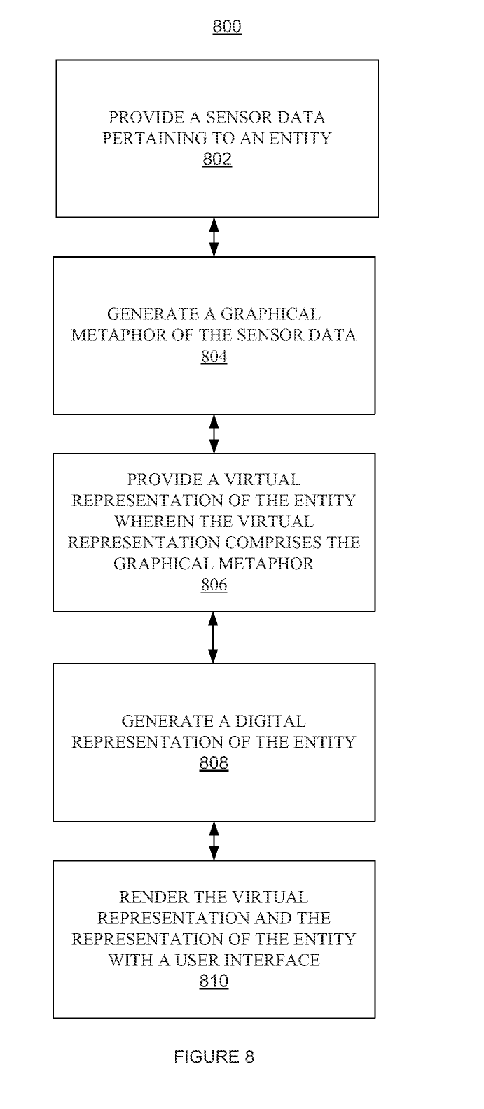

FIG. 8 shows a flowchart of another illustrative process 800 for augmented reality marketing in accordance with another embodiment. Block 802 typically indicates providing a sensor data pertaining to an entity, typically via a smart device 100 such as that described in connection with FIG. 1. However, in other embodiments, another device such as the portable electronic device 300 can include a sensor 320 as well. Data from all sensors may be acquired or, alternatively, selectively based upon rules.

Block 804 typically indicates generating a graphical metaphor of the sensor data. Typically, the graphical metaphor is generated by the AR server 114. However, in other embodiments, hardware and software functionalities of another device such as the portable electronic device 300 can perform the operation of block 804. In some embodiments, generating the graphical metaphor may be based upon a predetermined set of rules developed by an application developer. In other embodiments, the operation may selectively include predetermined rules and/or be derived, in part, on instructions from machine learning systems on the AR server 114.

Block 806 typically indicates providing a virtual representation of the entity. The virtual representation can include the graphical metaphor.

Block 808 typically indicates generating a digital representation of the entity. The digital representation can be acquired by a camera of the portable electronic device's input/output circuitry 312. The digital representation can be rendered by a user interface 306 with a display 308.

Block 810 typically indicates rendering the virtual representation and the representation of the entity with a user interface. In some embodiments, the user interface 306 can render the virtual representation and/or the representation of the entity by with a display 308. Alternatively, the user interface 306 can render the virtual representation and/or the representation of the entity in whole or in part with an speaker and/or a haptic device.

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense.

What is claimed is:

1. A method comprising:
providing a virtual representation of an object;
providing a real representation of the object;
rendering an association of the virtual representation and the real representation with a user interface; and
making a virtual coupon available to a user when the virtual representation and the real representation are rendered with the user interface.

2. The method of claim 1 further comprising determining an attribute of the virtual coupon according to at least one of a user state and a vendor state.

3. The method of claim 2 further comprising enabling a virtual coupon provider to modify the attribute of the virtual coupon in real-time.

4. The method of claim 1 further comprising integrating a graphical metaphor into the virtual representation according to an environmental characteristic of the object.

5. The method of claim 4, wherein the environmental characteristic comprises at least one of a physical environmental characteristic, a data environmental characteristic, a computer environmental characteristic and a user environmental characteristic.

6. The method of claim 1 further comprising determining an attribute of the virtual representation of the object according to a user characteristic.

7. The method of claim 1 further comprising coupling a sensor with the object.

8. The method of claim 7, wherein the graphical metaphor comprises a symbolic representation of a data obtained from the sensor.

9. The method of claim 8 further comprising coupling a smart device with the sensor.

10. The method of claim 9, wherein the smart device communicates the information to a server.

11. The method of claim 1, wherein a machine is caused to perform the method of claim 1 when a set of instructions in a form of a machine-readable medium is executed by the machine.

12. A computer-implemented method comprising:
providing a sensor data pertaining to an entity;
generating a graphical metaphor of the sensor data;
providing a virtual representation of the entity, wherein the virtual representation comprises the graphical metaphor;
generating a digital representation of the entity as perceived through the lens of a digital camera; and
rendering the virtual representation and the digital representation of the entity with a user interface.

13. The computer-implemented method of claim 12 further comprising generating a virtual coupon related the entity.

14. The computer-implemented method of claim 13, wherein the virtual coupon is generated when the user interface renders the virtual representation of the sensor data and the digital representation of the entity.

15. The computer-implemented method of claim 12, wherein rendering the virtual representation and the digital representation of the entity with the user interface further comprises:
overlapping the virtual representation and the digital representation of the entity with a user interface.

16. The computer-implemented method of claim 12 further comprising modifying an attribute of the graphical metaphor in real time based on a modulation of the sensor data.

17. The computer-implemented method of claim 12, wherein the sensor data is obtained from a virtual sensor.

18. A method comprising:
providing a computer system;
providing a user interface coupled with the computer system;
augmenting an image of an object rendered by the user interface with a virtual element; and
launching a credit application on the computer system if the image of the objected is augmented with the virtual element.

19. The method of claim 18 further comprising providing a credit to a user associated with the credit application.

20. The method of claim 19, wherein the value of the credit is determined by at least one of a bank account value, a location of a portable electronic device, a purchasing history and an inventory data.
